(19) United States
(12) Patent Application Publication
(10) Pub. No.: US 2026/0048711 A1
(43) Pub. Date: Feb. 19, 2026

(54) BACKUP POWER SUPPLY SYSTEM, MOBILE OBJECT, METHOD FOR CONTROLLING BACKUP POWER SUPPLY SYSTEM, AND PROGRAM

(71) Applicant: Panasonic Intellectual Property Management Co., Ltd., Osaka (JP)

(72) Inventors: TAKASHI KAWAI, Fukui (JP); YO KUMODA, Osaka (JP); YUTA NAGATOMI, Osaka (JP)

(21) Appl. No.: 19/104,253

(22) PCT Filed: Aug. 3, 2023
(86) PCT No.: PCT/JP2023/028434

§ 371 Date: Feb. 17, 2025

(30) Foreign Application Priority Data
Oct. 3, 2022 (JP) 2022-159651

(51) Int. Cl. B60R 16/033; H02J 1/08; H02J 7/00

(52) U.S. Cl. CPC B60R 16/033; H02J 1/086; H02J 7/0068; H02J 7/00712; H02J 2207/20; H02J 2207/50

(57) ABSTRACT

A backup power supply system is configured to be connected between a power supply and a load. The backup power supply system includes a first port, a second port, a conductive path, a power storage unit, a charging circuit, a discharging circuit, a switch; and a control circuit. The first port is configured to be connected to the power supply. The second port is configured to be connected to the load. The conductive path connects the first port to the second port. The charging circuit is provided in a first path connecting the conductive path to the power storage unit. The discharging circuit is provided in a second path that connecting the conductive path to the power storage unit. The switch is provided in the conductive path between the first port and the charging circuit and between the first port and the discharging circuit, and is configured to make the conductive path electrically conductive or electrically non-conductive. The control circuit is configured to control the switch, the charging circuit, and the discharging circuit.

### TECHNICAL FIELD

The present disclosure relates to a backup power supply system, a movable object, a method for controlling the backup power supply system, and a program. More specifically, the present disclosure relates to a backup power supply system configured to supply power to a load when a power supply is defective, a movable object having the backup power supply system installed thereto, a method for controlling the backup power supply system, and a program.

### BACKGROUND ART

The charging device disclosed in PTL 1 includes a secondary battery (a power supply), a charging circuit, a discharging circuit, an electric double layer capacitor (a power storage unit), a load drive circuit, and a load. The load drive circuit is provided in a conductive path connecting the secondary battery to the load. The charging circuit is provided in the conductive path between the rechargeable battery and the load drive circuit. The discharging circuit is connected in parallel to the charging circuit. The electric double layer capacitor is connected in the conductive path between a ground and a node between the charging circuit and the load.

In the charging device, the power stored in the electric double layer capacitor is discharged to the secondary battery (charges the secondary battery with the power) via the discharging circuit in order to extend the life of the electric double layer capacitor. At this moment, an output voltage of the electric double layer capacitor is supplied to the load via the load drive circuit from the conductive path not via the discharging circuit.

### CITATION LIST

### Patent Literature

PTL 1: Japanese Patent Laid-Open Publication No. 2009-171694

### SUMMARY OF INVENTION

In the charging device disclosed in PTL 1, the voltage supplied from the electric double layer capacitor to the load is supplied to the load not via the discharging circuit, and drops according to discharging of the electric double layer capacitor. Therefore, during the discharge of the electric double layer capacitor, the output voltage of the electric double layer capacitor drops accordingly below a voltage required for the load, thereby preventing the load from operating with the output voltage of the electric double layer capacitor.

A backup power supply system according to an aspect of the present disclosure is configured to be connected between a power supply and a load. The backup power supply system includes a first port, a second port, a conductive path, a power storage unit, a charging circuit, a discharging circuit, a switch, and a control circuit. The first port is configured to be connected to the power supply. The second port is configured to be connected to the load. The conductive path connects the first port to the second port. The charging circuit is provided in a first path connecting the conductive path to the power storage unit, and is configured to charge the power storage unit with power from the conductive path. The discharging circuit is provided in a second path connecting the conductive path to the power storage unit, and is configured to discharge power stored in the power storage unit to the conductive path. The switch is provided in the conductive path between the first port and the charging circuit and between the first port and the discharging circuit, and is configured to make the conductive path electrically conductive or electrically non-conductive. The control circuit is configured to control the switch, the charging circuit, and the discharging circuit.

A movable object according to an aspect of the present disclosure includes the backup power supply system, the power supply, the load, and a movable body having the backup power supply system, the power supply, and the load installed thereto.

A method for controlling a backup power supply system according to an aspect of the present disclosure is a method for controlling a backup power supply system connected between a power supply and a load. The backup power supply system includes a first port, a second port, a conductive path, a power storage unit, a charging circuit, a discharging circuit, and a switch. The first port is connected to the power supply. The second port is connected to the load. The conductive path connects the first port to the second port. The charging circuit is provided in a first path connecting the conductive path to the power storage unit, and is configured to charge the power storage unit with power from the conductive path. The discharging circuit is provided in a second path connecting the conductive path to the power storage unit, and is configured to discharge power stored in the power storage unit to the conductive path. The switch is provided in the conductive path between the first port and the charging circuit and between the first port and the discharging circuit, and is configured to make the conductive path electrically conductive or electrically non-conductive. In the method, the switch, the charging circuit, and the discharging circuit by a control circuit. In the controlling, when the power stored in the power storage unit is discharged, the power supply is charged with the stored power and the stored power is supplied to the load by discharging the power stored in the power storage unit to the conductive path via the discharging circuit while the charging circuit stops.

A program according to an aspect of the present disclosure causes one or more processors to execute the method for controlling the backup power supply system.

According to the present disclosure, the load may operate with the discharged power from the power storage unit even during the discharge of the power storage unit.

### BRIEF DESCRIPTION OF THE DRAWINGS

FIG. 1 is a block diagram of a backup power supply system according to an exemplary embodiment.

FIG. 2 is a side view, with partial cutaway, of a vehicle having the backup power supply system installed thereto.

FIG. 3 is a diagram for explaining an operation of the backup power supply system in a first mode.

FIG. 4 is a diagram for explaining an operation of the backup power supply system in a second mode.

FIG. 5 is a diagram for explaining an operation of the backup power supply system in a third mode.

FIG. 6 is a diagram for explaining an operation of the backup power supply system in a fourth mode.

FIG. 7 is a flowchart for explaining an operation of the backup power supply system.

FIG. 8 is a block diagram of a backup power supply system according to Modification 3.

### DESCRIPTION OF EMBODIMENT

### (1) EXEMPLARY EMBODIMENT

### (1-1) Outline

Backup power supply system 1 according to the present embodiment will be described below with reference to the drawings. The configuration described in the present embodiment is merely an example of the present disclosure. The present disclosure is not limited to the present embodiment, but numerous modifications can be made in light of design and the like without departing from the technical idea according to the present disclosure.

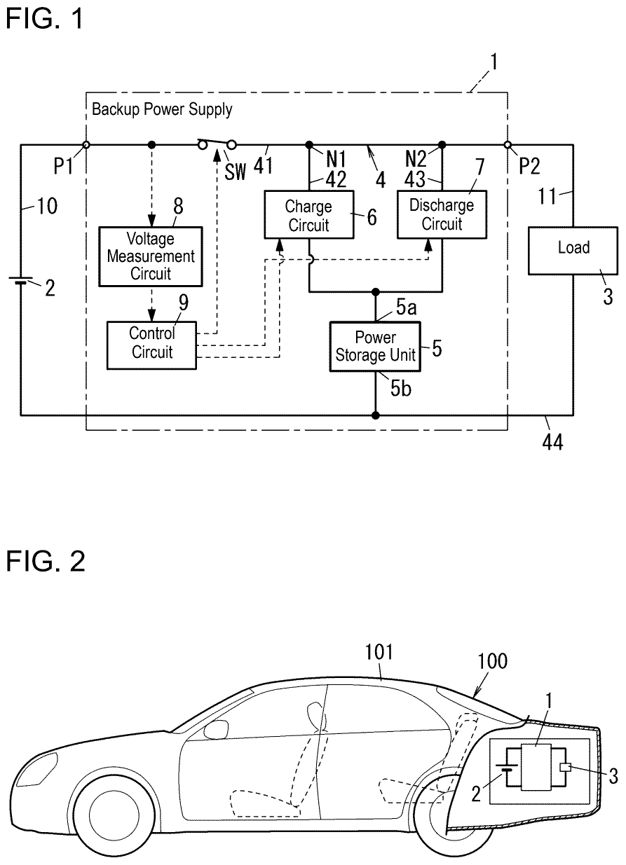

As illustrated in FIG. 1, backup power supply system 1 is installed to, for example, vehicle 100 (see FIG. 2). When power supply 2 operates normally, backup power supply system 1 supplies an output voltage of power supply 2 to load 3. When power supply 2 is defective, backup power supply system 1 supplies power to load 3 from power storage unit 5 instead of from power supply 2. As a result, load 3 continuously operates with the power supplied from power storage unit 5 even when power supply 2 is defective. The expression “power supply 2 is defective” refers to that the supply of power from power supply 2 to load 3 stops due to, for example, a failure, deterioration, or disconnection of power supply 2.

Backup power supply system 1 is thus installed to vehicle 100 having power supply 2 and load 3 installed thereto. In other words, vehicle 100 (a movable object) includes vehicle body 101 (a movable body), power supply 2, load 3, and backup power supply system 1. Power supply 2, load 3, and backup power supply system 1 are disposed in vehicle 100. In accordance with the present embodiment, backup power supply system 1 installed to vehicle 100 will be described. However, backup power supply system 1 may be installed to a movable object (e.g., airplane, ship, or train) other than vehicle 100.

Power supply 2 is a power supply installed to vehicle 100, and may be used to power load 3. Power supply 2 is, for example, a battery.

Load 3 is a load (e.g., an apparatus) installed to vehicle 100, and is, for example, a load that receives power from power supply 2 to continuously operate. Examples of load 3 include a shift-by-wire system, a door locking and unlocking device, and a braking system. The shift-by-wire system is configured to electrically change a shift position of an automatic transmission according to the position of a shift lever. The door locking and unlocking system is a system configured to electrically switch between the locking and unlocking of doors of vehicle 100. The brake system is a system configured to electrically activate a brake mechanism provided on each wheel of vehicle 100.

### (1-2) Detailed Description of Backup Power Supply System

As illustrated in FIG. 1, backup power supply system 1 includes first port P1, second port P2, electric path 4, switch SW, power storage unit 5, charging circuit 6, discharging circuit 7, voltage measurement circuit 8, and control circuit 9. Power storage unit 5 is not necessarily included in elements of backup power supply system 1.

### (1-2-1) First Port and Second Port

First port P1 is an input and output port configured to be connected to a positive electrode of power supply 2 via wiring 10. A negative electrode of power supply 2 is connected to ground line 44, which will be described later. First port P1 is configured to receive an output voltage of power supply 2 via wiring 10 and provides an output voltage of power storage unit 5 to power supply 2 via wiring 10.

Second port P2 is an output port configured to be connected to one end of load 3 via wiring 11. Another end of load 3 is connected to ground line 44, which will be described later. Second port P2 is configured to supply the output voltage of power supply 2 or the output voltage of power storage unit 5 to load 3 via wiring 11. Wirings 10 and 11 are made of, for example, wire harnesses.

### (1-2-2) Electric Path

Electric path 4 is an electric path configured to transmit the output voltage of power supply 2 from first port P1 to power storage unit 5 and second port P2, and to transmit the output voltage of power storage unit 5 to first port P1 and second port P2. Electric path 4 includes conductive path 41, which is a main electric path, charging path 42 (a first path), discharging path 43 (a second path), and ground line 44.

Conductive path 41 is an electric path (a power line) connecting first port P1 to second port P2. Conductive path 41 is configured to transmit the output voltage of power supply 2 from first port P1 to second port P2, and to transmit, to first port P1 and second port P2, the output voltage (discharge voltage) of discharging circuit 7 output (discharged) to conductive path 41.

Charging path 42 is an electric path including charging circuit 6, and connects node N1 of conductive path 41 to first end 5a of power storage unit 5, which will be described later. Charging path 42 is configured to input a voltage of conductive path 41 to power storage unit 5 via charging circuit 6.

Discharging path 43 is an electrical path including discharging circuit 7, and connects node N2 of conductive path 41 to first end 5a of power storage unit 5, which will be described later. In conductive path 41, node N1 is closer to first port P1 than node N2. Discharging path 43 is configured to discharge the output voltage (discharge voltage) of power storage unit 5 to conductive path 41 via discharging circuit 7.

Ground line 44 is an electric path maintained at a ground potential and is configured to be connected to a ground. Ground line 44 is connected to a negative electrode of power supply 2, second end 5b of power storage unit 5, and another end of load 3.

### (1-2-3) Power Storage Unit

Power storage unit 5 is a backup (i.e., auxiliary or reserve) power supply for power supply 2. In other words, power storage unit 5 is a power supply configured to supply power (voltage and current) to load 3 when power supply 2 is defective. Power storage unit 5 is, for example, an electric double layer capacitor (EDLC). Power storage unit 5 may include two or more power storage devices (e.g., electric double layer capacitors) electrically connected in parallel, in series, or in parallel and series to one another. In other words, power storage unit 5 may be implemented by a parallel or series circuit of plural power storage devices, or a combination thereof.

Power storage unit 5 has first end 5a and second end 5b. First end 5a of power storage unit 5 is an input and output end configured to receive a charge current and a charge voltage from charging circuit 6 and outputting (discharging) the power stored in power storage unit 5 to discharging circuit 7. First end 5a of power storage unit 5 is connected to one end of charging path 42 and one end of discharging path 43. Second end 5b of power storage unit 5 is connected to ground line 44.

### (1-2-4) Charging Circuit

Charging circuit 6 is configured to charge power storage unit 5 with the output voltage of power supply 2 while power supply 2 operates normally. More specifically, charging circuit 6 is configured to charge power storage unit 5 by changing (e.g., boosting) the voltage of conductive path 41 (i.e., the output voltage of power supply 2 input into conductive path 41 from first port P1), maintaining the changed voltage, and outputting the maintained voltage to power storage unit 5. Charging circuit 6 may be, for example, a boost and step-down DC-DC converter. Charging circuit 6 is provided in charging path 42. Charging circuit 6 operates and stops under the control of control circuit 9.

### (1-2-5) Discharging Circuit

Discharging circuit 7 is configured to supply power to load 3 by adjusting the power stored in power storage unit 5 to the voltage required for load 3 and to discharge the voltage to conductive path 41, instead of power supply 2 when power supply 2 is defective (in a second mode, which will be described later). Discharging circuit 7 is also configured to step down the voltage stored in power storage unit 5 to a predetermined threshold voltage by discharging the power stored in power storage unit 5 to conductive path 41 while power does not need to be suppled from power storage unit 5 to load 3 (in a third mode, which will be described later) when power supply 2 is defective. The voltage stored in power storage unit 5 stepped down to the threshold voltage, as described above, may extend a lifetime of power storage unit 5. When discharging the power stored in power storage unit 5 to conductive path 41, discharging circuit 7 changes the output voltage of power storage unit 5 to an appropriate value, and maintains the changed voltage after the changing to discharge the power to conductive path 41. Discharging circuit 7 operates and stops under the control of control circuit 9.

### (1-2-6) Switch

Switch SW is configured to make conductive path 41 electrically conductive or non-conductive, and is provided in conductive path 41. Switch SW is provided in conductive path 41 between first port P1 and charging circuit 6 and between first port P1 and discharging circuit 7. Switch SW is turned on and off under the control of control circuit 9, thereby making conductive path 41 electrically conductive or non-conductive. Conductive path 41 electrically non-conductive prevents the voltage of conductive path 41 from dropping due to the drop of the output voltage of power supply 2 when power supply 2 is defective (in the second mode, which will be described later). Switch SW is implemented by a semiconductor switching element, such as a metal-oxide-semiconductor field-effect transistor (MOSFET) or a mechanical switch, such as an electromagnetic relay.

### (1-2-7) Voltage Measurement Circuit

Voltage measurement circuit 8 is configured to measure the output voltage of power supply 2 by measuring the voltage of conductive path 41 (more specifically, the voltage of a portion of conductive path 41 between first port P1 and switch SW).

### (1-2-8) Control Circuit

Control circuit 9 is configured to control switch SW, charging circuit 6, and discharging circuit 7 according to the result of measurement by voltage measurement circuit 8 (i.e., voltage information relating to the output voltage of power supply 2) and status information (described later) obtained from an external device.

The status information indicates whether or not power needs to be supplied from power storage unit 5 to load 3 when power supply 2 is defective. The status information is indicated by, for example, ON and OFF statuses of an ignition signal (hereinafter, referred to as “IG signal”) of vehicle 100. The ON state of the IG signal means that vehicle 100 runs. The term “run” includes not only the state in which vehicle 100 runs, but also the state in which vehicle 100 is ready to start (i.e., the state in which the engine is ready to start for a vehicle with an engine, and the motor is ready to start for an electric automobile). Therefore, “run” includes the state in which a vehicle stops temporarily due to, e.g., waiting for a traffic light. In accordance with the present embodiment, the state in which vehicle 100 runs is the state in which load 3 needs to operate and power needs to be supplied from power storage unit 5 to load 3 when power supply 2 is defective. The OFF state of the IG signal means the state in which vehicle 100 stops. The term “stop” means the state in which vehicle 100 continuously stops, e.g., vehicle 100 is parked. In accordance with the present embodiment, the state in which vehicle 100 stops is the state in which load 3 needs to operate and power does not need to be supplied from power storage unit 5 to load 3 when power supply 2 is defective.

In detail, control circuit 9 is configured to determine, based on the result of measurement by voltage measurement circuit 8, whether or not power supply 2 is normal. In other words, control circuit 9 determines whether or not power supply 2 is normal according to whether or not the output voltage of power supply 2 measured by voltage measurement circuit 8 is within a predetermined voltage range. Specifically, control circuit 9 determines that power supply 2 is normal when the output voltage of power supply 2 measured by voltage measurement circuit 8 is within the predetermined voltage range. Control circuit 9 determines that power supply 2 is not normal (i.e., power supply 2 is defective) when the output voltage of power supply 2 measured by voltage measurement circuit 8 is not within the predetermined voltage range. The expression “power supply 2 is normal” means that power supply 2 is not defective, and that supply of power from power supply 2 to load 3 does not stop due to, for example, failure, deterioration, or disconnection of power supply 2.

Based on the status information from the external device, control circuit 9 determines whether or not vehicle 100 runs (i.e., whether or not power needs to be supplied from power storage unit 5 to load 3 when power supply 2 is defective).

Control circuit 9 also determines whether or not the output voltage (i.e., the stored voltage) of power storage unit 5 is lower than or equal to threshold voltage.

Control circuit 9 is configured to control switch SW, charging circuit 6, and discharging circuit 7 based on the above determination results (i.e., whether or not power supply 2 is normal, whether or not vehicle 100 runs, and whether or not the output voltage of power storage unit 5 is lower than or equal to the threshold voltage). With this control, control circuit 9 supplies the output voltage of power supply 2 to load 3, charges power storage unit 5 with the output voltage of power supply 2, and discharges the power stored in power storage unit 5 to conductive path 41.

Particularly when the stored power of power storage unit 5 is discharged to conductive path 41, control circuit 9 causes the power stored in power storage unit 5 to be discharged to conductive path 41 via discharging circuit 7 while charging circuit 6 stops, so that the stored power charges power supply 2 and is supplied to load 3. At this moment, the voltage (output voltage of discharging circuit 7) discharged from power storage unit 5 to conductive path 41 is adjusted by discharging circuit 7 to an appropriate value. Therefore, even when the output voltage of power storage unit 5 drops due to the discharge of power storage unit 5, the voltage supplied from discharging circuit 7 to load 3 (output voltage of discharging circuit 7) does not excessively drop. This configuration prevents the voltage supplied from power storage unit 5 to load 3 from dropping during the discharge of power storage unit 5, thereby allowing load 3 to operate with the discharge of power storage unit 5.

Control circuit 9 continuously discharges power storage unit 5 until the output voltage of power storage unit 5 drops to the threshold voltage. When the output voltage of power storage unit 5 drops to the threshold voltage, control circuit 9 stops discharging circuit 7 to stop the discharge of power storage unit 5. The output voltage of power storage unit 5 drops to the threshold voltage (i.e., relatively low voltage), accordingly extending the lifetime of power storage unit 5. Control circuit 9 stops discharging circuit 7 to supply the output voltage of power supply 2 to load 3. This configuration allows load 3 to operate with the output voltage of power supply 2 even when the output voltage of power storage unit 5 drops to the threshold voltage.

In accordance with the present embodiment, the status information is indicated by ON/OFF information of the IG signal. However, the status information may be indicated by various signals that may be obtained from vehicle 100 (a shift position signal, a vehicle speed signal, and sensor signals used in automatic driving and advanced driver assistance system (ADAS)) instead of the IG signal.

Control circuit 9 is implemented by, for example, a microcomputer including a processor and memory. In other words, control circuit 9 is implemented by a computer system including a processor and memory. The computer system functions as control circuit 9 by the processor executing an appropriate program. The program may be previously recorded in the memory, or may be provided through a telecommunication line, such as the Internet, or recorded on a non-transitory recording medium, such as a memory card. Control circuit 9 is configured to perform digital control using a microcomputer, but may also be configured to perform analog control without any microcomputer.

### (1-3) Operation

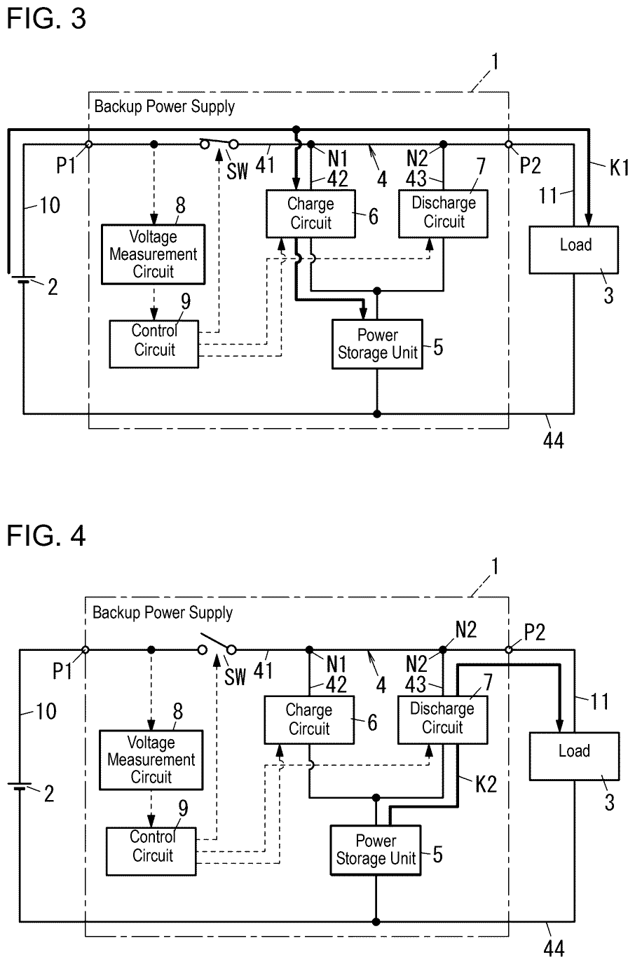

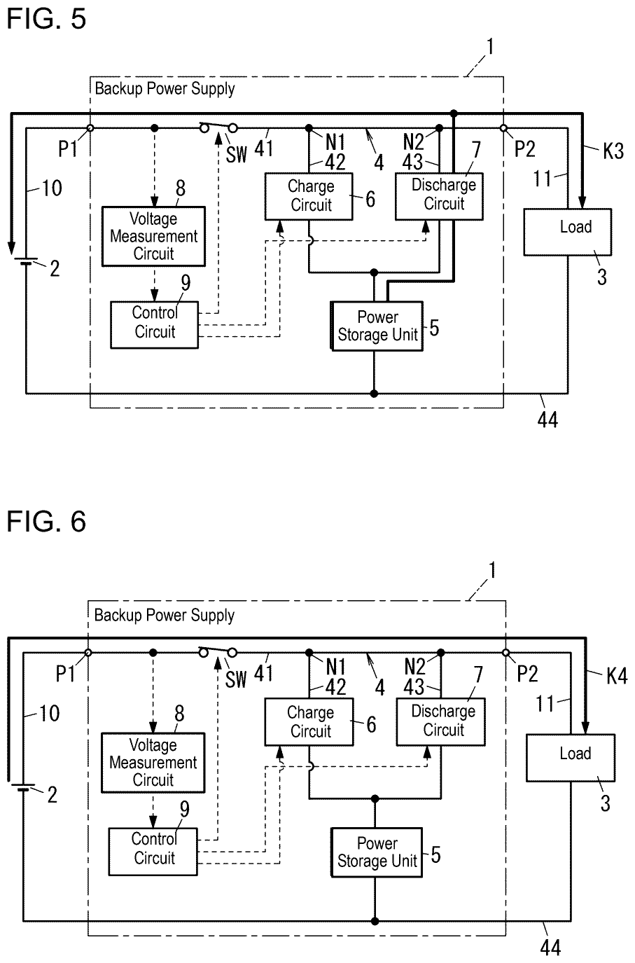

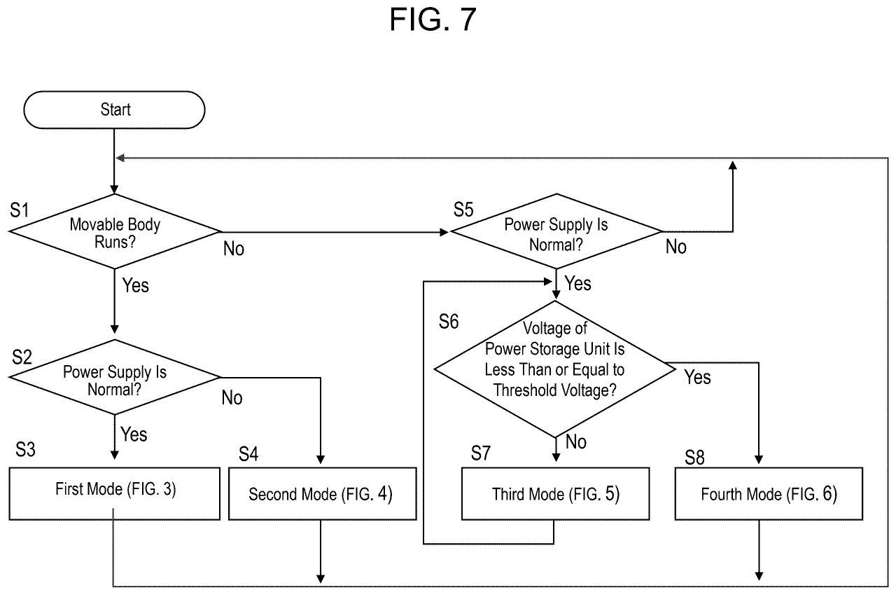

An example of an operation of backup power supply system 1 will be described with referring to FIGS. 3-6.

### (1-3-1) Operation When Vehicle Runs and Power Supply Is Normal

An operation performed when vehicle 100 runs and power supply 2 is normal will be described below with referring to FIG. 3.

Control circuit 9 determines, based on the result of measurement by voltage measurement circuit 8 and the IG signal, whether or not power supply 2 is normal and whether or not vehicle 100 runs. When the determination results indicate that power supply 2 is normal (i.e., the output voltage of power supply 2 is within the predetermined voltage range) and vehicle 100 runs (i.e., the state in which power needs to be supplied from power storage unit 5 to load 3 when power supply 2 is defective), control circuit 9 operates in a first mode.

In the first mode, control circuit 9 turns on switch SW to activate charging circuit 6 (i.e., controls charging circuit 6 to charge power storage unit 5 with the output power of power supply 2) and stop discharging circuit 7 (i.e., controls discharging circuit 7 to prevent the power stored in power storage unit 5 from being discharged to conductive path 41).

In this mode, as indicated by arrow K1 shown in FIG. 3, the output power of power supply 2 is supplied to load 3 via wiring 10, conductive path 41, and wiring 11 to allow load 3 to operate. Moreover, charging circuit 6 charges power storage unit 5 with the output power of power supply 2.

### (1-3-2) Operation When Vehicle Runs and Power Supply Is defective (Power Supply Backup Operation)

An operation performed when vehicle 100 runs and power supply 2 is defective will be described below with referring to FIG. 4.

Control circuit 9 determines, based on the result of measurement by voltage measurement circuit 8 and the IG signal, whether or not power supply 2 is normal and whether or not vehicle 100 runs. When the determination results indicate that power supply 2 is defective (i.e., the output voltage of power supply 2 is not within the predetermined voltage range) and vehicle 100 runs (i.e., the state in which power needs to be supplied from power storage unit 5 to load 3 when power supply 2 is defective), control circuit 9 operates in a second mode.

In the second mode, control circuit 9 turns off switch SW, stops charging circuit 6 (i.e., controls charging circuit 6 to prevent power storage unit 5 from being charged with the output power of power supply 2), and activates discharging circuit 7 (i.e., controls discharging circuit 7 to discharge the power stored in power storage unit 5 to conductive path 41).

In other words, when it is determined that power supply 2 is defective, switch SW is turned off, thereby disconnecting power supply 2 from conductive path 41 and preventing the voltage of conductive path 41 from dropping according to the output voltage of power supply 2. Then, when charging circuit 6 stops and discharging circuit 7 operates, the power stored in power storage unit 5 is discharged to conductive path 41 via discharging circuit 7 and supplied to load 3, as indicated by arrow K2 shown in FIG. 4. This configuration allows power to be continuously supplied to load 3 with the discharge of power storage unit 5 even when power supply 2 is defective.

### (1-3-3) Operation When Vehicle Runs and Power Supply Is Normal

### Step 1

An operation (step 1) performed when vehicle 100 stops and power supply 2 is normal will be described with referring to FIG. 5.

Control circuit 9 determines, based on the result of measurement performed by voltage measurement circuit 8 and the IG signal, whether or not power supply 2 is normal and whether or not vehicle 100 runs. Control circuit 9 also determines whether or not the voltage (i.e., the output voltage) stored in power storage unit 5 is lower than or equal to a threshold voltage. When the determination results indicate that power supply 2 is normal (i.e., the output voltage of power supply 2 is within the predetermined voltage range) and vehicle 100 does not run (i.e., vehicle 100 stops and power does not need to be supplied from power storage unit 5 to load 3 when power supply 2 is defective), and the voltage stored in power storage unit 5 is neither lower than nor equal to the threshold voltage (i.e., the voltage stored in power is relatively high), control circuit 9 operates in a third mode.

In the third mode, control circuit 9 turns on switch SW, stops charging circuit 6 (i.e., controls charging circuit 6 to prevent power storage unit 5 from being charged with the output power of power supply 2), and activates discharging circuit 7 (i.e., controls discharging circuit 7 to discharge the power stored in power storage unit 5 to conductive path 41).

This configuration causes the power stored in power storage unit 5 to be discharged to conductive path 41 via discharging circuit 7, as indicated by arrow K3 shown in FIG. 5. The power stored in power storage unit 5 discharged to conductive path 41 is then supplied to load 3 via conductive path 41 and charges power supply 2. Therefore, during the discharge of power storage unit 5, the output voltage of power storage unit 5 is adjusted to an appropriate value by discharging circuit 7. This configuration prevents the voltage supplied from power storage unit 5 to load 3 (output voltage of discharging circuit 7) from dropping. As a result, load 3 operates with the discharge of power storage unit 5 during the discharge of power storage unit 5.

### (1-3-4) Operation When Vehicle Stops and Power Supply Is Normal

### Step 2

An operation (step 2) performed when vehicle 100 stops and power supply 2 is normal will be described with referring to FIG. 6.

Control circuit 9 determines, based on the result of measurement performed by voltage measurement circuit 8 and the IG signal, whether or not power supply 2 is normal and whether or not vehicle 100 runs. Control circuit 9 also determines whether or not the voltage (i.e., the output voltage) stored in power storage unit 5 is lower than or equal to the threshold voltage. When the determination results indicate that power supply 2 is normal (i.e., the output voltage of power supply 2 is within the predetermined voltage range), vehicle 100 does not run (i.e., vehicle 100 stops and power does not need to be supplied from power storage unit 5 to load 3 when power supply 2 is defective), and the voltage stored in power storage unit 5 is lower than or equal to the threshold voltage (i.e., the stored voltage is relatively high), control circuit 9 operates in a fourth mode.

In the fourth mode, control circuit 9 turns on switch SW, stops charging circuit 6 (i.e., controls charging circuit 6 to prevent power storage unit 5 from being charged with the output power of power supply 2), and stops discharging circuit 7 (i.e., controls discharging circuit 7 to prevent the power stored in power storage unit 5 from being discharged to conductive path 41).

In other words, in the third mode, when the voltage stored in power storage unit 5 drops to the threshold voltage, control circuit 9 switches to the fourth mode and further stops discharging circuit 7 to stop the discharge of power storage unit 5. This configuration maintains the voltage stored in power storage unit 5 at the threshold voltage (i.e., relatively low voltage). This configuration thus maintains the voltage stored in power storage unit 5 at a relatively low voltage, thus extending the lifetime of power storage unit 5. Moreover, as indicated by arrow K4 shown in FIG. 6, after the discharge of power storage unit 5, the output voltage of power supply 2 is supplied to load 3 via conductive path 41. Therefore, after the discharge of power storage unit 5, load 3 can operate with the output voltage of power supply 2 even when the voltage (i.e., output voltage) stored in power storage unit 5 is low.

### (1-3-5) Description of Operation With Referring to Flowchart

An operation of backup power supply system 1 will be described below with referring to FIG. 7.

Control circuit 9 determines, based on the IG signal, whether or not vehicle 100, a movable object, runs (step S1). When the determination result indicates that vehicle 100 runs (“Yes” in step S1), control circuit 9 further determines, based on the result of measurement performed by voltage measurement circuit 8, whether or not power supply 2 is normal (step S2). When the determination result indicates that power supply 2 is normal (“Yes” in step S2), control circuit 9 proceeds to step S3, and operates in the first mode described above (see FIG. 3). In this operation mode, as illustrated by arrow K1 shown in FIG. 3, the output power of power supply 2 is supplied to load 3 via wiring 10, conductive path 41, and wiring 11, thereby allowing load 3 to operate. Moreover, charging circuit 6 charges power storage unit 5 with the output voltage of power supply 2. The process then returns to step S1.

When the determination result in step S2 indicates that power supply 2 is not normal (i.e., power supply 2 is defective) (“No” in step S2), control circuit 9 proceeds to step S4, and operates in the second mode described above (see FIG. 4). In this operation mode, as indicated by arrow K2 shown in FIG. 4, the power stored in power storage unit 5 is discharged to conductive path 41 via discharging circuit 7, and is supplied to load 3. As a result, power is continuously supplied to load 3 due to the discharge of power storage unit 5 even when power supply 2 is defective. The processing then returns to step S1.

When the determination result in step S1 indicates that vehicle 100 does not run (i.e., state in which vehicle 100 stops) (“No” in step S1), control circuit 9 further determines, based on the result of measurement performed by voltage measurement circuit 8, whether or not power supply 2 is normal (step S5). When the determination result indicates that power supply 2 is not normal (i.e., power supply 2 is defective) (“No” in step S5), the processing returns to step S1.

On the other hand, when the determination result in step S1 indicates that power supply 2 is normal (“Yes” in step S5), control circuit 9 further determines whether or not the voltage stored in power storage unit 5 is lower than or equal to threshold voltage (step S6). When the determination result in step S6 indicates that the voltage stored in power storage unit 5 is neither lower than nor equal to the threshold voltage (“No” in step S6), control circuit 9 proceeds to step S7 and operates in the third mode described above (see FIG. 5). In this mode, the power stored in power storage unit 5 is discharged to conductive path 41 via discharging circuit 7, as indicated by arrow K3 shown in FIG. 5. The power stored in power storage unit 5 discharged to conductive path 41 is then supplied to load 3 via conductive path 41 and charges power supply 2. Therefore, during the discharge of power storage unit 5, the output voltage of power storage unit 5 is adjusted by discharging circuit 7 to an appropriate value. This configuration prevents the voltage supplied from power storage unit 5 to load 3 (the output voltage of discharging circuit 7) from dropping. This operation allows load 3 to operate with the discharge of power storage unit 5 during the discharge of power storage unit 5. The processing then returns to step S6.

When the determination result in step S6 indicates that the voltage stored in power storage unit 5 is lower than or equal to the threshold voltage (“Yes” in step S6), control circuit 9 proceeds to step S8 and operates in the fourth mode described above. In the fourth mode, as described above, discharging circuit 7 stops to stop the discharge of power storage unit 5. This operation maintains the voltage stored in power storage unit 5 at the threshold voltage (that is a relatively low voltage), thereby extending the lifetime of power storage unit 5. In the fourth mode (i.e., after the discharge of storage unit 5), the output voltage of power supply 2 is supplied to load 3 via conductive path 41, as indicated by arrow K4 shown in FIG. 6. Therefore, after the discharge of power storage unit 5, load 3 operates with the output voltage of power supply 2 even when the voltage (i.e., output voltage) stored in power storage unit 5 is low. The processing then returns to step S1.

### (1-4) Advantageous Effect

As described above, backup power supply system 1 according to the present embodiment is a backup power supply system configured to be connected between power supply 2 and load 3. Backup power supply system 1 includes first port P1, second port P2, conductive path 41, power storage unit 5, charging circuit 6, discharging circuit 7, switch SW, and control circuit 9. First port P1 is configured to be connected to power supply 2. Second port P2 is configured to be connected to load 3. Conductive path 41 connects first port P1 to second port P2. Charging circuit 6 is provided in charging path 42 (a first path) connecting conductive path 41 to power storage unit 5, and is configured to charge power storage unit 5 with power from conductive path 41. Discharging circuit 7 is provided in discharging path 43 (a second path) connecting conductive path 41 to power storage unit 5, and is configured to discharge the power stored in power storage unit 5 to conductive path 41. Switch SW is provided in conductive path 41 between first port P1 and charging circuit 6 and between first port P1 and discharging circuit 7, and is configured to make conductive path 41 electrically conductive or electrically non-conductive. Control circuit 9 controls switch SW, charging circuit 6, and discharging circuit 7.

In this configuration, the discharge of power storage unit 5 can be performed by control circuit 9 causing the power stored in power storage unit 5 to be discharged to conductive path 41 via discharging circuit 7 while stopping charging circuit 6. As a result, power supply 2 is charged with the power stored in power storage unit 5 (which is regenerated), and the stored power is simultaneously supplied to load 3. At this moment, the voltage discharged by discharging circuit 7 from power storage unit 5 to conductive path 41 (i.e., the output voltage of discharging circuit 7) is adjusted by discharging circuit 7 to an appropriate value. Therefore, even when the output voltage of power storage unit 5 drops due to the discharge of power storage unit 5, the voltage supplied from discharging circuit 7 to load 3 (the output voltage of discharging circuit 7) does not excessively drop. This configuration prevents the voltage supplied from power storage unit 5 to load 3 from dropping even during the discharge of power storage unit 5. This operation allows load 3 to operate with the discharge of power storage unit 5 even during the discharge of power storage unit 5.

### (1-5) Method for Controlling Backup Power Supply System

Functions of backup power supply system 1 according to the embodiment may be implemented by, for example, a method for controlling the backup power supply system, a computer program (program), or a non-transitory recording medium having the computer program recorded thereon.

A method for controlling a backup power supply system according to an aspect is a method for controlling backup power supply system 1 configured to be connected between power supply 2 and load 3. Backup power supply system 1 includes first port P1, second port P2, conductive path 41, power storage unit 5, charging circuit 6, discharging circuit 7, switch SW, and control circuit 9. First port P1 is configured to be connected to power supply 2. Second port P2 is configured to be connected to load 3. Conductive path 41 connects first port P1 to second port P2. Charging circuit 6 is provided in charging path 42 (a first path) connecting conductive path 41 to power storage unit 5, and is configured to charge power storage unit 5 with power from conductive path 41. Discharging circuit 7 is provided in discharging path 43 (a second path) connecting conductive path 41 to power storage unit 5, and is configured to discharge power stored in power storage unit 5 to conductive path 41. Switch SW is provided in conductive path 41 between first port P1 and charging circuit 6 and between first port P1 and discharging circuit 7, and is configured to make conductive path 41 electrically conductive or electrically non-conductive. The method for controlling backup power supply system 1 includes controlling switch SW, charging circuit 6, and discharging circuit 7 by control circuit 9. In the controlling, when discharging the power stored in power storage unit 5, power supply 2 is charged with the stored power and the stored power is suppled to load 3 by discharging the power stored in power storage unit 5 to conductive path 41 via discharging circuit 7 while stopping charging circuit 6.

A program according to an aspect causes one or more processors to execute the method for controlling the backup power supply system.

A non-transitory recording medium according to an aspect is a non-transitory recording medium recording thereon a program for causing one or more processors to execute the method for controlling the backup power supply system.

### (1-6) Modification

Modifications of the above embodiment will be described below. The modifications below may also be adopted in combination as appropriate.

### Modification 1

In the above embodiment, the discharge voltage (i.e., output voltage) of discharging circuit 7 may be different between the second mode (a first operating mode) (i.e., during backup operation) and the third mode (a second operating mode) (i.e., during power regeneration).

In detail, when discharging circuit 7 discharges the power stored in power storage unit 5 to conductive path 41 in the second mode and the third mode, discharging circuit 7 is configured to change the discharge voltage of discharging circuit 7 to a first voltage or a second voltage depending on whether the current mode is the second mode or the third mode. Discharging circuit 7 then discharges the power stored in power storage unit 5 to conductive path 41 while maintaining the discharge voltage of discharging circuit 7 at the changed voltage (i.e., the first voltage or the second voltage).

The first voltage is the discharge voltage of discharging circuit 7 in the second mode. In the second mode, due to defective of power supply 2, the discharge voltage of discharging circuit 7 (i.e., the voltage obtained by changing the voltage stored in power storage unit 5 by discharging circuit 7) is supplied to load 3 instead of from power supply 2. Therefore, the first voltage is set to an operating voltage suitable for the operation of load 3. More specifically, the operating voltage range of load 3 may be within the voltage range, e.g., from 8 V to 16 V. The first voltage is set to a voltage (e.g., 10 V) near the lower limit value within the operating voltage range (8 V to 16 V) of load 3 to allow load 3 to operate with saved energy.

The second voltage is the discharge voltage of discharging circuit 7 in the third mode. In the third mode, power supply 2 is charged (regenerated) with the discharge voltage of discharging circuit 7 (i.e., the voltage obtained by changing the power stored in power storage unit 5 by discharging circuit 7). Therefore, the second voltage is set to a charge voltage suitable for charging power supply 2. More specifically, the set range of the output voltage of power supply 2 may be within the voltage range, e.g., from 8 V to 16 V. The second voltage is set to the upper limit value (16 V) within the set range (8 V to 16 V) of the output voltage of power supply 2 to limit the charge current to power supply 2 and charge power supply 2 slowly.

In Modification 1, for example, the first voltage (e.g., 10 V) is set to a value lower than the second voltage (e.g., 16 V). However, the first voltage may be the same value as or higher than the second voltage.

In Modification 1, the discharge voltage of discharging circuit 7 is changed to a discharge voltage suitable for each mode (second mode and third mode), so that the power stored in power storage unit 5 may be discharged to conductive path 41 via discharging circuit 7.

### Modification 2

In the above embodiment, the upper limit value of the discharge current (i.e., output current) of discharging circuit 7 may be different between the second mode (the first operating mode) (i.e., during backup operation) and the third mode (a second operating mode) (i.e., during power regeneration).

More specifically, when discharging circuit 7 discharges the power stored in power storage unit 5 to conductive path 41 in the second mode and the third mode, discharging circuit 7 changes the upper limit value of the discharge current of discharging circuit 7 to a first upper limit value or a second upper limit value depending on whether the current mode is the second mode or third mode. Discharging circuit 7 then discharges the power stored in power storage unit 5 to conductive path 41 while maintaining the discharge current of discharging circuit 7 not to exceed the upper limit value after the change of voltage.

The first upper limit value is the upper limit value of the discharge current of discharging circuit 7 in the second mode. In the second mode, the discharge current of discharging circuit 7 is supplied from conductive path 41 to load 3 via wiring 11. Therefore, the first upper limit value is set to the upper limit value of an allowable current (e.g., 30 A) of wiring 11.

The second upper limit value is the upper limit value of the discharge current of discharging circuit 7 in the third mode. In the third mode, power supply 2 is charged (regenerated) with the discharge current of discharging circuit 7 from conductive path 41 via wiring 10. Therefore, the second upper limit value is set to the upper limit value of the allowable current (e.g., 5 A) of wiring 10.

In Modification 2, for example, the first upper limit value (e.g., 30) is set to be a value larger than the second upper limit value (e.g., 5 A). However, the first upper limit value may be the same as or smaller than the second upper limit value.

According to Modification 2, the discharge current of discharging circuit 7 is changed to discharge current suitable for each mode (the second mode and the third mode), so that the power stored in power storage unit 5 may be discharged to conductive path 41 via discharging circuit 7.

### Modification 3

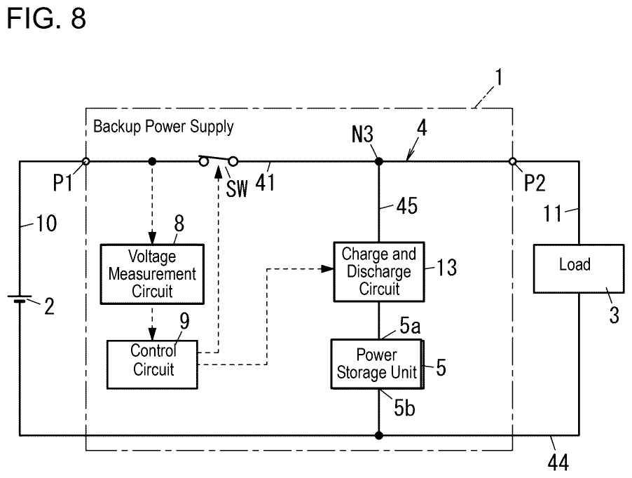

In the above embodiment, charging circuit 6 and discharging circuit 7 are separately configured (see FIG. 1), but charging circuit 6 and discharging circuit 7 may be combined into a single charging and discharging circuit 13 (see FIG. 8). In this case, as illustrated in FIG. 8, charging path 42 and discharging path 43 in the above embodiment are combined into single charging and discharging path 45. Charging and discharging path 45 connects node N3 of conductive path 41 to first end 5a of power storage unit 5. Charging and discharging circuit 13 is provided in charging and discharging path 45. This configuration reduces the number of components of backup power supply system 1, accordingly reducing the size of backup power supply system 1.

### Modification 4

In the above embodiment, charging circuit 6 may include one of a boost circuit and a step-down circuit, and discharging circuit 7 may include another of the boost circuit and the step-down circuit. In other words, charging circuit 6 may include a boost circuit, and discharging circuit 7 may include a step-down circuit. Alternatively, charging circuit 6 may include a step-down circuit and discharging circuit 7 may include a boost circuit. In these configurations, charging circuit 6 and discharging circuit 7 may be implemented by a boost circuit and a step-down circuit (i.e., known circuits).

### Modification 5

In the above embodiment, control circuit 9 controls switch SW, charging circuit 6 and discharging circuit 7 based on both the voltage information and the status information. However, control circuit 9 may control switch SW, charging circuit 6, and discharging circuit 7 based on at least one of the voltage information or the status information.

### (2) CONCLUSION

According to the above embodiment and modifications described, the present disclosure includes the aspects below.

A backup power supply system (1) according to a first aspect is configured to be connected between a power supply (2) and a load (3). The backup power supply system (1) includes a first port (P1), a second port (P2), a conductive path (41), a power storage unit (5), a charging circuit (6), a discharging circuit (7), a switch (SW), and a control circuit (9). The first port (P1) is configured to be connected to the power supply (2). The second port (P2) is configured to be connected to the load (3). The conductive path (41) connects the first port (P1) to the second port (P2). The charging circuit (6) is provided in a first path (42) connecting the conductive path (41) to the power storage unit (5), and is configured to charge the power storage unit (5) with power from the conductive path (41). The discharging circuit (7) is provided in a second path (43) connecting the conductive path (41) to the power storage unit (5), and is configured to discharge power stored in the power storage unit (5) to the conductive path (41). The switch (SW) is provided in the conductive path (41) between the first port (P1) and the charging circuit (6) and between the first port (P1) and the discharging circuit (7), and is configured to make the conductive path (41) electrically conductive or electrically non-conductive. The control circuit (9) is configured to control the switch (SW), the charging circuit (6), and the discharging circuit (7).

In this configuration, the discharge of power storage unit (5) can be performed by the control circuit (9) causing the power stored in power storage unit (5) to be discharged to conductive path (41) via discharging circuit (7) while charging circuit (6) is stopped. As a result, the power supply (2) is charged (regenerated) with the power stored in the power storage unit (5) by the discharging circuit (7), and the power stored in the power storage unit (5) is simultaneously supplied to the load (3). At this moment, the voltage discharged from power storage unit (5) to conductive path (41) (i.e., the discharge voltage of the discharging circuit (7)) is adjusted by discharging circuit (7) to an appropriate value. Therefore, even when the output voltage of the power storage unit (5) drops due to the discharge of the power storage unit (5), the voltage supplied from the discharging circuit (7) to the load (3) (i.e., the output voltage of the discharging circuit (7)) does not excessively drop. This configuration prevents the voltage supplied from the power storage unit (5) to the load (3) (i.e., the output voltage of the discharge circuit (7)) from dropping during the discharge of the power storage unit (5). This configuration allows the load (3) to operate with the discharge of the power storage unit (5) during the discharge of the power storage unit (5).

In the backup power supply system (1) according to a second aspect, in the first aspect, when discharging the power stored in the power storage unit (5), the control circuit (9) is configured to charge the power supply (2) with the power stored in the power storage unit (5) and supply the power stored in the power storage unit (5) to the load (3) by causing the power stored in the power storage unit (5) to be discharged to the conductive path (41) via the discharging circuit (7) while stopping the charging circuit (6).

In this configuration, when the power stored in the power storage unit (5) is discharged, the power supply (2) is charged (regenerated) with the power stored in the power storage unit (5) from the conductive path (41) and simultaneously supply the power stored in the power storage unit (5) to the load (3). At this moment, the voltage supplied from the power storage unit (5) to the load (3) (i.e., the discharge voltage of the discharging circuit (7)) is adjusted by the discharging circuit (7) to an appropriate value. Therefore, even when the output voltage of the power storage unit (5) drops, the voltage supplied from the discharging circuit (7) to the load (3) (i.e., the output voltage of the power storage unit (5)) does not excessively drop. This configuration prevents the voltage supplied from the power storage unit (5) to the load (3) from dropping during the discharge of the power storage unit (5). This configuration allows the load (3) to operate with the discharge of the power storage unit (5) during the discharge of the power storage unit (5).

In the backup power supply system (1) according to a third aspect, in the first or aspect, the control circuit (9) is configured to obtain at least one of voltage information and status information, and control the switch (SW), the charging circuit (6), and the discharging circuit (7) based on the at least one of the voltage information and the status information obtained. The voltage information relates to an output voltage of the power supply (2). The status information indicates whether or not power needs to be supplied from the power storage unit (5) to the load (3) when the power supply (2) is defective.

In this configuration, the switch (SW), the charging circuit (6) and the discharging circuit (7) may be controlled based on at least one of the voltage information and the status information.

The backup power supply system (1) according to a fourth aspect, in the third aspect, further includes a voltage measurement circuit (8) configure to measure a voltage of a portion of the conductive path (41) between the first port (P1) and the switch (SW). The control circuit (9) is configured to obtain the voltage information by obtaining a result of measurement performed by the voltage measurement circuit (8).

In this configuration, the voltage information (i.e., the information relating to the output voltage of the power supply (2)) may be properly obtained by the voltage measurement circuit (8).

In the backup power supply system (1) according to a fifth aspect, in the third or fourth aspect, the status information is an ignition signal obtained from a vehicle (100) having the backup power supply system (1) installed thereto. An ON state of the ignition signal indicates a state in which power needs to be supplied from the power storage unit (5) to the load (3) when the power supply (2) is defective, and an OFF state of the ignition signal indicates a state in which power does not need to be supplied from the power storage unit (5) to the load (3) when the power supply (2) is defective.

In this configuration, the status information may be obtained by the ignition signal (i.e., by a signal that may be readily obtained).

In the backup power supply system (1) according to a sixth aspect, in any one of the first to fifth aspects, a state in which power needs to be supplied from the power storage unit (5) to the load (3) when the power supply (2) is defective is a state in which a vehicle having the backup power supply system (1) installed thereto runs. A state in which power does not need to be supplied from the power storage unit (5) to the load (3) when the power supply (2) is defective is a state in which the vehicle (100) stops.

In this configuration, the switch (SW), the charging circuit (6), and the discharging circuit (7) may be controlled according to whether the vehicle (100) having the backup power supply system (1) installed thereto runs or stops.

In the backup power supply system (1) according to a seventh aspect, in any one of the first to sixth aspects, the charging circuit (6) and the discharging circuit (7) are implemented by a single charging and discharging circuit (13).

In this configuration, the number of components in the backup power supply system (1) is reduced. This configuration reduces the size of the backup power supply system (1).

In the backup power supply system (1) according to an eight aspect, in any one of the first to seventh aspects, the charging circuit (6) includes one of a boost circuit and a step-down circuit, and the discharging circuit (7) includes another of the boost circuit and the step-down circuit.

In this configuration, the charging circuit (6) and the discharging circuit (7) are implemented by the boost circuit and the step-down circuit (i.e., known circuits).

In the backup power supply system (1) according to a ninth aspect, in any one of the first to eight aspects, while power does not need to be supplied from the power storage unit (5) to the load (3) when the power supply (2) is defective, if an output voltage of the power supply (2) is within a predetermined voltage range and a voltage stored in the power storage unit (5) is neither lower than nor equal to threshold voltage, the control circuit (9) is configured to turn on the switch (SW), control the charging circuit (6) to prevent the power storage unit (5) from being charged with an output power of the power supply (2), and control the discharging circuit (7) to cause the power stored in the power storage unit (5) to be discharged to the conductive path (41).

In this configuration, while power does not need to be supplied from the power storage unit (5) to the load (3) when the power supply (2) is defective, if the output voltage of the power supply (2) is within the predetermined voltage range (i.e., the power supply (2) is normal) and (iii) the voltage stored in the power storage unit (5) is neither lower than nor equal to the threshold voltage (i.e., the voltage stored in the power storage unit (5) is relatively high), the power stored in the power storage unit (5) may be discharged to the conductive path (41) via the discharging circuit (7). Therefore, during the discharge of the power storage unit (5), the output voltage of the power storage unit (5) is adjusted by the discharging circuit (7) to an appropriate value. This prevents the voltage supplied from the power storage unit (5) to the load (3) (i.e., the output voltage of the discharging circuit (7)) from dropping. This configuration allows the load (3) to operate with the discharge of the power storage unit (5) during the discharge of the power storage unit (5).

In the backup power supply system (1) according to a tenth aspect, in any one of the ninth aspect, while power does not need to be supplied from the power storage unit (5) to the load (3) when the power supply (2) is defective, if the output voltage of the power supply (2) is within the predetermined voltage range and the voltage stored in the power storage unit (5) is lower than or equal to the threshold voltage, the control circuit (9) is configured to turn on the switch (SW), control the charging circuit (6) to prevent the power storage unit (5) from being charged with the output power of the power supply (2), and control the discharging circuit (7) to prevent the power stored in the power storage unit (5) from being discharged to the conductive path (41).

In this configuration, while power does not need to be supplied from the power storage unit (5) to the load (3) when the power supply (2) is defective, if the output voltage of the power supply (2) is within the predetermined voltage range (i.e., the power supply (2) is normal) and the voltage stored in the power storage unit (5) is lower than or equal to the predetermined threshold voltage, the voltage stored in the power storage unit (5) is maintained at the threshold voltage (that is, relatively low voltage). This extends the lifetime of power storage unit (5). Moreover, since the output voltage of the power supply (2) is supplied to the load (3) via the conductive path (41), the load (3) operates with the output voltage of the power supply (2) even when the voltage stored in the power storage unit (5) is low.

In the backup power supply system (1) according to an eleventh aspect, in the ninth or tenth aspect, while power needs to be supplied from the power storage unit (5) to the load (3) when the power supply (2) is defective, if the output voltage of the power supply (2) is within the predetermined voltage range, the control circuit (9) is configured to turn on the switch (SW), control the charging circuit (6) to charge the power storage unit (5) with the output power of the power supply (2), and control the discharging circuit (7) to prevent the power stored in the power storage unit (5) from being discharged to the conductive path (41).

In this configuration, while power needs to be supplied from the power storage unit (5) to the load (3) when the power supply (2) is defective, if the output voltage of the power supply (2) is within the predetermined voltage range (i.e., the power supply (2) is normal), the output power of the power supply (2) may be used to supply power to the load (3) and charge the power storage unit (5).

In the backup power supply system (1) according to a twelfth aspect, in any one of the ninth to eleventh aspects, while power needs to be supplied from the power storage unit (5) to the load (3) when the power supply (2) is defective, if the output voltage of the power supply (2) is not within the predetermined voltage range, the control circuit (9) is configured to turn off the switch (SW), control the charging circuit (6) to prevent the power storage unit (5) from being charged with the output power of the power supply (2), and control the discharging circuit (7) to cause the power stored in the power storage unit (5) to be discharged to the conductive path (41).

In this configuration, while power needs to be supplied from the power storage unit (5) to the load (3) when the power supply (2) is defective, if the output voltage of the power supply (2) is not within the predetermined voltage range (i.e., the power supply (2) is defective), the discharging circuit (7) may discharge the power stored in the power storage unit (5) to the conductive path (41). This configuration allows power to be supplied to the load (3) (i.e., the load (3) can operate) with the discharge of the power storage unit (5) when the power supply (2) is defective.

The backup power supply system (1) according to a thirteenth aspect, in any one of the first to twelfth aspects, is configured to operate in a first operating mode and a second operating mode. In the first operating mode, the control circuit (9) turns off the switch (SW), controls the charging circuit (6) to prevent the power storage unit (5) from being charged with the output power of the power supply (2), and controls the discharging circuit (7) to cause the power stored in the power storage unit (2) to be discharged to the conductive path (41). In the second operating mode, the control circuit (9) turns on the switch (SW), controls the charging circuit (6) to prevent the power storage unit (5) from being charged with the output power of the power supply (2), and controls the discharging circuit (7) to cause the power stored in the power storage unit (5) to be discharged to the conductive path (41). When the discharging circuit (7) discharges the power stored in the power storage unit (5) to the conductive path (41), a discharge voltage of the discharging circuit (7) in the first operating mode is different from a discharge voltage of the discharging circuit (7) in the second operating mode.

In this configuration, the discharge voltage of the discharging circuit (7) may be changed to the discharge voltage suitable for each operating mode (the first operating mode and the second operating mode) so that the power stored in the power storage unit (5) may be discharged to the conductive path (41) via the discharging circuit (7).

In the backup power supply system (1) according to a fourteenth aspect, in any one of the first to thirteenth aspects, the backup power supply system in a first operating mode and a second operating mode. In the first operating mode, the control circuit (9) turns off the switch (SW), controls the charging circuit (6) to prevent the power storage unit (5) from being charged with the output power of the power supply (2), and controls the discharging circuit (7) to cause the power stored in the power storage unit (5) to be discharged to the conductive path (41). In the second operating mode, the control circuit (9) turns on the switch (SW), controls the charging circuit (6) to prevent the power storage unit (5) from being charged with the output power of the power supply (2), and controls the discharging circuit (7) to cause the power stored in the power storage unit (5) to be discharged to the conductive path (41). When the discharging circuit (7) discharges the power stored in the power storage unit (5) to the conductive path (41), an upper limit value of a discharge current of the discharging circuit (7) in the first operating mode is different from an upper limit value of a discharge current of the discharging circuit (7) in the second operating mode.

In this configuration, the upper limit value of the discharge current of the discharging circuit (7) may be changed to an upper limit value suitable for each operating mode (the first operating mode and the second operating mode), so that the power stored in the power storage unit (5) may be discharged to the conductive path (41) via the discharging circuit (7).

A movable object (100) according to a fifteenth aspect includes the backup power supply system (1) according to any one of the first to thirteenth aspects, the power supply (2), the load (3), and a movable body (101) having the backup power supply system (1), the power supply (2), and the load (3) installed thereto.

In this configuration, a movable object (100) includes the backup power supply system (1) described above.

A method for controlling a backup power supply system (1) according to a sixteenth aspect is a method for controlling the backup power supply system (1) connected between a power supply (2) and a load (3). The backup power supply system (1) includes a first port (P1), a second port (P2), a conductive path (41), a power storage unit (5), a charging circuit (6), a discharging circuit (7), a switch (SW), and a control circuit (9). The first port (P1) is connected to the power supply (2). The second port (P2) is connected to the load (3). The conductive path (41) connects the first port (P1) to the second port (P2). The charging circuit (6) is provided in a first path (42) connecting the conductive path (41) to the power storage unit (5), and is configured to charge the power storage unit (5) with power from the conductive path (41). The discharging circuit (7) is provided in a second path (43) connecting the conductive path (41) to the power storage unit (5), and is configured to discharge power stored in the power storage unit (5) to the conductive path (41). The switch (SW) is provided in the conductive path (41) between the first port (P1) and the charging circuit (6) and between the first port (P1) and the discharging circuit (7), and is configured to make the conductive path (41) electrically conductive or electrically non-conductive. The method for controlling the backup power supply system (1) includes controlling the switch (SW), the charging circuit (6), and the discharging circuit (7) by the control circuit (9). In the controlling, when discharging the power stored in the power storage unit (5), the power supply (2) is charged with the stored power and the stored power is supplied to the load (3) by discharging the power stored in the power storage unit (5) to the conductive path (41) via the discharging circuit (7) while stopping the charging circuit (6).

In this configuration, during the discharge of the power storage unit (5), the power supply (2) is charged (regenerated) with the power stored in the power storage unit (5) from the conductive path (41) to the power supply (2) and the stored power is simultaneously supplied to the load (3). At this moment, the voltage supplied from the power storage unit (5) to the load (3) (i.e., the output voltage of the discharging circuit (7)) is adjusted to an appropriate value by the discharging circuit (7). Therefore, even when the output voltage of the power storage unit (5) drops due to the discharge of the power storage unit (5), the voltage supplied from the discharging circuit (7) to the load (3) (i.e., the output voltage of the discharging circuit (7)) does not excessively drop. This prevents the voltage supplied from the power storage unit (5) to the load (3) (i.e., the output voltage of the discharge circuit (7)) from dropping during the discharge of the power storage unit (5). This configuration allows the load (3) to operate with the discharge of the power storage unit (5) during the discharge of the power storage unit (5).

A program according to a seventeenth aspect causes one or more processors to execute the method for controlling the backup power supply system according to the sixteenth aspect.

This configuration provides a program for causing one or more processors to execute the method for controlling the backup power supply system.

### REFERENCE MARKS IN THE DRAWINGS

1 backup power supply system
2 power supply
3 load
5 power storage unit
6 charging circuit
7 discharging circuit
8 voltage measurement circuit
9 control circuit
13 charging and discharging circuit
P1 first port
P2 second port
41 conductive path
42 charging path (first path)
43 discharging path (second path)
100 vehicle (movable object)
101 vehicle body (movable body)

1. A backup power supply system configured to be connected between a power supply and a load, the backup power supply system comprising:
a first port configured to be connected to the power supply;
a second port configured to be connected to the load;
a conductive path connects the first port to the second port;
a power storage unit;
a charging circuit provided in a first path connecting the conductive path to the power storage unit, the charging circuit being configured to charge the power storage unit with power from the conductive path;
a discharging circuit provided in a second path connecting the conductive path to the power storage unit, the discharging circuit being configured to discharge power stored in the power storage unit to the conductive path;
a switch provided in the conductive path between the first port and the charging circuit and between the first port and the discharging circuit, the switch being configured to make the conductive path electrically conductive or electrically non-conductive; and
a control circuit configured to control the switch, the charging circuit, and the discharging circuit.

2. The backup power supply system according to claim 1, wherein, when discharging the power stored in the power storage unit, the control circuit is configured to charge the power supply with the power stored in the power storage unit and supply the power stored in the power storage unit to the load by causing the power stored in the power storage unit to be discharged to the conductive path via the discharging circuit while stopping the charging circuit.

3. The backup power supply system according to claim 1, wherein the control circuit is configured to obtain at least one of voltage information and status information, and to control the switch, the charging circuit, and the discharging circuit based on the at least one of the voltage information and the status information obtained, the voltage information relating to an output voltage of the power supply, the status information indicating whether or not power does not need to be supplied from the power storage unit to the load when the power supply is defective.

4. The backup power supply system according to claim 3, further comprising
a voltage measurement circuit configured to measure a voltage of a portion the conductive path between the first port and the switch, wherein
the control circuit is configured to obtain the voltage information by obtaining a result of measurement performed by the voltage measurement circuit.

5. The backup power supply system according to claim 3, wherein
the status information is an ignition signal obtained from a vehicle having the backup power supply system installed thereto,
an ON state of the ignition signal indicates a state in which power needs to be supplied from the power storage unit to the load when the power supply is defective, and
an OFF state of the ignition signal indicates a state in which power does not need to be supplied from the power storage unit to the load when the power supply is defective.

6. The backup power supply system according to claim 1, wherein
a state in which power needs to be supplied from the power storage unit to the load when the power supply is defective is a state in which a vehicle having the backup power supply system installed thereto runs, and
a state in which power does not need to be supplied from the power storage unit to the load when the power supply is defective is a state in which the vehicle stops.

7. The backup power supply system according to claim 1, wherein the charging circuit and the discharging circuit are implemented by a single charging and discharging circuit.

8. The backup power supply system according to claim 1, wherein the charging circuit includes one of a boost circuit and a step-down circuit, and the discharging circuit includes another of the boost circuit and the step-down circuit.

9. The backup power supply system according to claim 1, wherein, while power does not need to be supplied from the power storage unit to the load when the power supply is defective, if an output voltage of the power supply is within a predetermined voltage range and a voltage stored in the power storage unit is neither lower than nor equal to a threshold voltage, the control circuit is configured to:
turn on the switch;
control the charging circuit to prevent the power storage unit from being charged with an output power of the power supply; and
control the discharging circuit to discharge the power stored in the power storage unit to the conductive path.

10. The backup power supply system according to claim 9, wherein, while power does not need to be supplied from the power storage unit to the load when the power supply is defective, if the output voltage of the power supply is within the predetermined voltage range and the voltage of the power storage unit is lower than or equal to the threshold voltage, the control circuit is configured to:
turn on the switch;
control the charging circuit to prevent the power storage unit from being charged with the output power of the power supply; and
control the discharging circuit to prevent the power stored in the power storage unit from being discharged to the conductive path.

11. The backup power supply system according to claim 9, wherein, while power does not need to be supplied from the power storage unit to the load when the power supply is defective, if the output voltage of the power supply is within the predetermined voltage range, the control circuit is configured to:
turn on the switch;
control the charging circuit to charge the power storage unit with the output power of the power supply; and
control the discharging circuit to prevent the power stored in the power storage unit from being discharged to the conductive path.

12. The backup power supply system according to claim 9, wherein, while power needs to be supplied from the power storage unit to the load when the power supply is defective, if the output voltage of the power supply is not within the predetermined voltage range, the control circuit is configured to:
turn off the switch;
control the charging circuit to prevent the power storage unit from being charged with the output power of the power supply; and
control the discharging circuit to discharge the power stored in the power storage unit to the conductive path.

13. The backup power supply system according to claim 1, wherein
the backup power supply system is configured to:
operate in a first operating mode in which the control circuit turns off the switch, controls the charging circuit to prevent the power storage unit from being charged with an output power of the power supply, and controls the discharging circuit to discharge the power stored in the power storage unit to the conductive path; and
operate in a second operating in which the control circuit turns on the switch, controls the charging circuit to prevent the power storage unit from being charged with the output power of the power supply, and controls the discharging circuit to discharge the power stored in the power storage unit to the conductive path, and
when the discharging circuit discharges the power stored in the power storage unit to the conductive path, a discharge voltage of the discharging circuit in the first operating mode is different from the discharge voltage of the discharging circuit in the second operating mode.

14. The backup power supply system according to claim 1, wherein
the backup power supply system is configured to:
operate in a first operating mode in which the control circuit turns off the switch, controls the charging circuit to prevent the power storage unit from being charged with an output power of the power supply, and controls the discharging circuit to discharge the power stored in the power storage unit to the conductive path; and
operate in a second operating mode in which the control circuit turns on the switch, controls the charging circuit to prevent the power storage unit from being charged with the output power of the power supply, and controls the discharging circuit to discharge the power stored in the power storage unit to the conductive path, and
when the discharging circuit discharges the power stored in the power storage unit to the conductive path, an upper limit value of a discharge current of the discharging circuit in the first operating mode is different from an upper limit value of the discharge current of the discharging circuit in the second operating mode.

15. A movable object comprising:
the backup power supply system according to claim 1;
the power supply;
the load; and
a movable body having the backup power supply system, the power supply, and the load installed thereto.

16. A method for controlling a backup power supply system connected between a power supply and a load, the method comprising:
providing the backup power supply system including
a first port connected to the power supply,
a second port connected to the load,
a conductive path connecting the first port to the second port,
a power storage unit,
a charging circuit provided in a first path connecting the conductive path to the power storage unit, the charging circuit being configured to charge the power storage unit with power from the conductive path unit,
a discharging circuit provided in a second path connecting the conductive path to the power storage unit, the discharging circuit being configured to discharge power stored in the power storage unit to the conductive path, and
a switch provided in the conductive path between the first port and the charging circuit and between the first port and the discharging circuit to make the conductive path electrically conductive or electrically non-conductive; and
controlling the switch, the charging circuit, and the discharging circuit by a control circuit, wherein
said controlling comprises, when discharging the power stored in the power storage unit, charging the power supply with the stored power and suppling the stored power to the load by discharging the power stored in the power storage unit to the conductive path via the discharging circuit while the charging circuit stops.

17. A program for causing one or more processers to execute the method for controlling the backup power supply system according to claim 16.
